(19) United States
(12) Patent Application Publication
(10) Pub. No.: US 2016/0352643 A1
(43) Pub. Date: Dec. 1, 2016

(54) METHODS FOR DISCARDING RADIO LINK CONTROL (RLC) SERVICE DATA UNIT (SDU) AND BASE STATION

(71) Applicant: SHARP KABUSHIKI KAISHA, Sakai City, Osaka (JP)

(72) Inventors: Fangying XIAO, Shanghai (CN); Renmao LIU, Shanghai (CN)

(73) Assignee: SHARP KABUSHIKI KAISHA, Sakai City,Osaka (JP)

(21) Appl. No.: 15/116,746

(22) PCT Filed: Feb. 4, 2015
(86) PCT No.: PCT/CN2015/072213

§ 371 Date: Aug. 4, 2016

(30) Foreign Application Priority Data
Feb. 8, 2014 (CN) 201410046099.9

(51) Int. Cl. H04L 12/823; H04W 76/04; H04L 12/841

(52) U.S. Cl. CPC H04L 47/32; H04L 47/28; H04W 76/046

(57) ABSTRACT

The present disclosure provides a method performed in a Secondary evolved NodeB (SeNB) for discarding a Radio Link Control (RLC) Service Data Unit (SDU) received from a Master eNB (MeNB). The method comprises: starting a RLC discarding timer associated with the RLC SDU received from the MeNB; removing the RLC discarding timer when the RLC discarding timer has not expired and any portion of the RLC SDU has been mapped to a RLC Protocol Data Unit (PDU); and discarding the RLC SDU when the RLC discarding timer expires. The present disclosure also provides a MeNB and a SeNB. With the present disclosure, it is possible to save storage space by reducing storage of expired RLC SDUs in the SeNB and save radio transmission resources by avoiding transmission of expired RLC SDUs.

### TECHNICAL FIELD

The present disclosure relates to mobile communications, and more particularly, to a method for discarding a Radio Link Control (RLC) Service Data Unit (SDU) and a base station.

### BACKGROUND

The user plane protocol stack at Layer 2 in the 3^{rd} Generation Partnership Project (3GPP) Long Term Evolution (LTE) system consists of three sub-layers. They are, from high to low: Packet Data Convergence Protocol (PDCP) layer, Radio Link Control (RLC) layer and Media Access Control (MAC) layer. At the transmitting side, traffic is provided to a particular layer by receiving Service Data Units (SDUs) from a higher layer and Protocol Data Units (PDUs) are outputted to a lower layer. For example, the RLC layer receives packets from the PDCP layer. These packets are PDCP PDUs for the PDCP layer, but also RLC SDUs for the RLC layer. An inverse process occurs at the receiving side. That is, each layer sends SDUs to a higher layer, which receives them as PDUs. The PDCP SDUs are subjected to IP header compression, encryption and addition of PDCP headers and then mapped to PDCP PDUs. The RLC SDUs are segmented and concatenated according to a size specified at the MAC layer, added with RLC headers and then mapped to RLC PDUs. Each PDCP SDU is identified by a PDCP sequence number (SN). Each PDCP SDU has the same SN as its corresponding PDCP PDU and RLC SDU. Each RLC PDU is identified by an RLC SN.

In 3GPP LTE Release 11, each radio bearer has a PDCP entity and an RLC entity. Each Base Station (BS), or NodeB or evolved NodeB (eNB), and each User Equipment (UE) has a MAC entity. The time for which a PDCP SDU is stored in the BS and the UE is controlled by a discard timer. Upon receiving a PDCP SDU from a higher layer, the PDCP layer starts an associated discard timer. When the discard timer expires, its associated PSCP SDU is discarded and an indication is sent to the RLC layer in the same BS or UE. When such indication is received by the RLC layer, if its corresponding RLC SDU has not been mapped to a RLC PDU, the RLC SDU will be discarded. Here, the UE can be a user terminal, a user node, a mobile terminal or a tablet computer.

The 3GPP LTE Release 12, which is currently being developed, involves standardization for dual connectivity enabled UE, Master eNB (MeNB) and Secondary eNB (SeNB). A MeNB maintains radio resource management and measurement configurations for a UE, and requests from a SeNB additional resources (also referred to as “serving cell”) for the UE based on a received measurement report, a traffic condition or a bearer type. Upon receiving the request from the MeNB, the SeNB either configures a serving cell for the UE, or rejects the request due to lack of sufficient resources.

Based on different schemes for bearer separation and the user plane protocol stack, in 3GPP TSG-RAN2 Meeting 83bis, two user plane architectures, 1A and 3C, have been determined as standardization options for the dual connectivity deployment. As shown in FIG. 1, the option 3C has the following features: (1) the MeNB communicates with a traffic gateway via an S1-U interface; (2) the bearer separation occurs in the MeNB; and (3) for a separated bearer, its corresponding RLC entity exists in both the MeNB and the SeNB. In the option 3C, the RLC entity at the SeNB interacts with a higher layer (i.e., a PDCP entity at the MeNB) via an Xn interface (which includes an X2 interface).

In a non-dual-connectivity deployment, since the PDCP entity and the RLC entity are located in one single BS, delay control for RLC SDUs can be provided by delay control for PDCP SDUs. That is, when a PDCP SDU has been discarded due to expiration of a discard timer, if its corresponding RLC SDU has not been mapped to an RLC PDU, the RLC SDU will be discarded. In the above non-dual-connectivity deployment, the process for discarding RLC SDUs can be implemented inside the BS and no further standardization is needed.

However, in the option 3C for dual connectivity deployment, the PDCP entity and one of the RLC entities corresponding to a separated bearer is located in the MeNB while the other one of the RLC entities is located in the SeNB. The existing solutions for the non-dual-connectivity deployment cannot solve the problem associated with delay control for RLC SDUs in the SeNB, such that the obsolete RLC SDUs will be stored and transmitted in the SeNB for a long time, resulting in wastes of storage space and radio transmission resources at the SeNB.

There is thus a need in the dual connectivity deployment for a mechanism for discarding an RLC SDU received from the MeNB in the SeNB, when no portion of the RLC SDU has been mapped to an RLC PDU and its corresponding PDCP SDU has been discarded due to expiration.

### SUMMARY

In order to solve the above problems, the present disclosure provides a method for discarding an RLC SDU and a base station.

In particular, according to a first aspect of the present disclosure, a method performed in a Secondary evolved NodeB (SeNB) for discarding a Radio Link Control (RLC) Service Data Unit (SDU) received from a Master eNB (MeNB) is provided. The method comprises: starting a RLC discarding timer associated with the RLC SDU received from the MeNB; removing the RLC discarding timer when the RLC discarding timer has not expired and any portion of the RLC SDU has been mapped to a RLC Protocol Data Unit (PDU); and discarding the RLC SDU when the RLC discarding timer expires.

In an embodiment, the RLC discarding timer is set in response to a request message requesting additional resources for a User Equipment (UE) or in response to an inter-node Radio Resource Control (RRC) message, and the RLC discarding timer satisfies a condition that its associated RLC SDU is discarded at the time when, or after, a corresponding Packet Data Convergence Protocol (PDCP) SDU in the MeNB expires.

According to a second aspect of the present disclosure, a method performed in a Master evolved NodeB (MeNB) for discarding a Radio Link Control (RLC) Service Data Unit (SDU) received from the Master eNB (MeNB) in a Secondary eNB (SeNB) is provided. The method comprises: discarding, when a discarding timer associated with a Packet Data Convergence Protocol (PDCP) SDU expires, the PDCP SDU; and transmitting, when a PDCP Protocol Data Unit (PDU) corresponding to the discarded PDCP SDU has been transmitted to the SeNB, an indication message to the SeNB to discard the RLC SDU corresponding to the PDCP PDU.

In an embodiment, when the PDCP PDU to which the discarded PDCP SDU is mapped is stored locally, the PDCP PDU is discarded.

In an embodiment, the method further comprises: storing a sequence number of each PDCP SDU that has expired; transmitting the indication message to the SeNB when there are a preset number of sequence numbers of expired PDCP SDUs that have been stored, or when a first timer expires, the first timer defining a maximum time interval for the MeNB to transmit the indication message to the SeNB.

In an embodiment, the method further comprises: storing a sequence number of each PDCP SDU that has expired; transmitting the indication message to the SeNB when a second timer expires, the second timer defining a time interval for the MeNB to transmit the indication message to the SeNB.

In an embodiment, the method further comprises: storing a sequence number of each PDCP SDU that has expired; transmitting the indication message to the SeNB when a third timer expires, the third timer defining a time interval for the MeNB to transmit the indication message to the SeNB. The indication message includes a minimum sequence number among the expired PDCP SDUs and a bitmap of the expired PDCP SDUs, the minimum sequence number being a minimum sequence number among PDCP SDUs that have been transmitted by the SeNB and have expired during a timing period of the third timer.

In an embodiment, the method further comprises: storing a sequence number of each PDCP SDU that has expired; transmitting the indication message to the SeNB when a difference between a maximum sequence number and a minimum sequence number among the expired PDCP SDUs is larger than or equal to a length of a bitmap, or when a fourth timer expires, the fourth timer defining a maximum time interval for the MeNB to transmit the indication message to the SeNB. The indication message includes the minimum sequence number among the expired PDCP SDUs and the bitmap, the maximum sequence number being a maximum sequence number among PDCP SDUs that have expired in the MeNB during a timing period of the fourth timer, the minimum sequence number being a minimum sequence number among PDCP SDUs that have been transmitted by the SeNB and have expired during the timing period of the fourth timer.

In an embodiment, the first, second, third or fourth timer is configured via a Radio Resource Control (RRC) configuration/reconfiguration message.

According to a third aspect of the present disclosure, a Secondary evolved NodeB (SeNB) for discarding a Radio Link Control (RLC) Service Data Unit (SDU) received from a Master eNB (MeNB) is provided. The SeNB comprises: a timer starting unit configured to start a RLC discarding timer associated with the RLC SDU received from the MeNB; a removing unit configured to remove the RLC discarding timer when the RLC discarding timer has not expired and any portion of the RLC SDU has been mapped to a RLC Protocol Data Unit (PDU); and a discarding unit configured to discard the RLC SDU when the RLC discarding timer expires.

In an embodiment, the RLC discarding timer is set in response to a request message requesting additional resources for a User Equipment (UE) or in response to an inter-node Radio Resource Control (RRC) message, and the RLC discarding timer satisfies a condition that its associated RLC SDU is discarded at the time when, or after, a corresponding Packet Data Convergence Protocol (PDCP) SDU in the MeNB expires.

According to a fourth aspect of the present disclosure, a Master evolved NodeB (MeNB) for discarding a Radio Link Control (RLC) Service Data Unit (SDU) received from the Master eNB (MeNB) in a Secondary eNB (SeNB) is provided. The MeNB comprises: a first discarding unit configured to discard, when a discarding timer associated with a Packet Data Convergence Protocol (PDCP) SDU expires, the PDCP SDU; and a transmitting unit configured to transmit, when a PDCP Protocol Data Unit (PDU) corresponding to the discarded PDCP SDU has been transmitted to the SeNB, an indication message to the SeNB to discard the RLC SDU corresponding to the PDCP PDU.

In an embodiment, the MeNB further comprises: a second discarding unit configured to discard, when the PDCP PDU to which the discarded PDCP SDU is mapped is stored locally, the PDCP PDU.

In an embodiment, the MeNB further comprises: a storage unit configured to store a sequence number of each PDCP SDU that has expired. The transmitting unit is configured to transmit the indication message to the SeNB when there are a preset number of sequence numbers of expired PDCP SDUs that have been stored, or when a first timer expires, the first timer defining a maximum time interval for the MeNB to transmit the indication message to the SeNB.

In an embodiment, the MeNB further comprises: a storage unit configured to store a sequence number of each PDCP SDU that has expired. The transmitting unit is configured to transmit the indication message to the SeNB when a second timer expires, the second timer defining a time interval for the MeNB to transmit the indication message to the SeNB.

In an embodiment, the MeNB further comprises: a storage unit configured to store a sequence number of each PDCP SDU that has expired. The transmitting unit is configured to transmit the indication message to the SeNB when a third timer expires, the third timer defining a time interval for the MeNB to transmit the indication message to the SeNB. The indication message includes a minimum sequence number among the expired PDCP SDUs and a bitmap of the expired PDCP SDUs, the minimum sequence number being a minimum sequence number among PDCP SDUs that have been transmitted by the SeNB and have expired during a timing period of the third timer.

In an embodiment, the MeNB further comprises: a storage unit configured to store a sequence number of each PDCP SDU that has expired. The transmitting unit is configured to transmit the indication message to the SeNB when a difference between a maximum sequence number and a minimum sequence number among the expired PDCP SDUs is larger than or equal to a length of a bitmap, or when a fourth timer expires, the fourth timer defining a maximum time interval for the MeNB to transmit the indication message to the SeNB. The indication message includes the minimum sequence number among the expired PDCP SDUs and the bitmap, the maximum sequence number being a maximum sequence number among PDCP SDUs that have expired in the MeNB during a timing period of the fourth timer, the minimum sequence number being a minimum sequence number among PDCP SDUs that have been transmitted by the SeNB and have expired during the timing period of the fourth timer.

In an embodiment, the first, second, third or fourth timer is configured via a Radio Resource Control (RRC) configuration/reconfiguration message.

According to the present disclosure, an RLC SDU received from a MeNB can be discarded in the SeNB when no portion of the RLC SDU has been mapped to an RLC PDU and its corresponding PDCP SDU has been discarded due to expiration. In this way, with the present disclosure, it is possible to save storage space by reducing storage of expired RLC SDUs in the SeNB and save radio transmission resources by avoiding transmission of expired RLC SDUs.

### BRIEF DESCRIPTION OF THE DRAWINGS

The above and other objects, features and advantages will be more apparent from the following description of embodiments with reference to the figures, in which:

FIG. 1 is a schematic diagram showing an option 3C for dual connectivity deployment as specified in 3GPP TR 36.842;

FIG. 2 is a flowchart illustrating a method for discarding an RLC SDU in a SeNB according to an embodiment of the present disclosure;

FIG. 3 is a flowchart illustrating a method in a MeNB for transmitting to a SeNB an indication message to discarding an RLC SDU according to an embodiment of the present disclosure;

FIG. 4 is a flowchart illustrating another method in a MeNB for transmitting to a SeNB an indication message to discarding an RLC SDU according to an embodiment of the present disclosure;

FIG. 5 is a flowchart illustrating another method in a MeNB for transmitting to a SeNB an indication message to discarding an RLC SDU according to an embodiment of the present disclosure;

FIG. 6 is a schematic diagram showing a bitmap according to an embodiment of the present disclosure;

FIG. 7 is a flowchart illustrating another method in a MeNB for transmitting to a SeNB an indication message to discarding an RLC SDU according to an embodiment of the present disclosure;

FIG. 8 is a flowchart illustrating another method in a MeNB for transmitting to a SeNB an indication message to discarding an RLC SDU according to an embodiment of the present disclosure;

FIG. 9 is a block diagram of a SeNB according to an embodiment of the present disclosure; and

FIG. 10 is a block diagram of a MeNB according to an embodiment of the present disclosure.

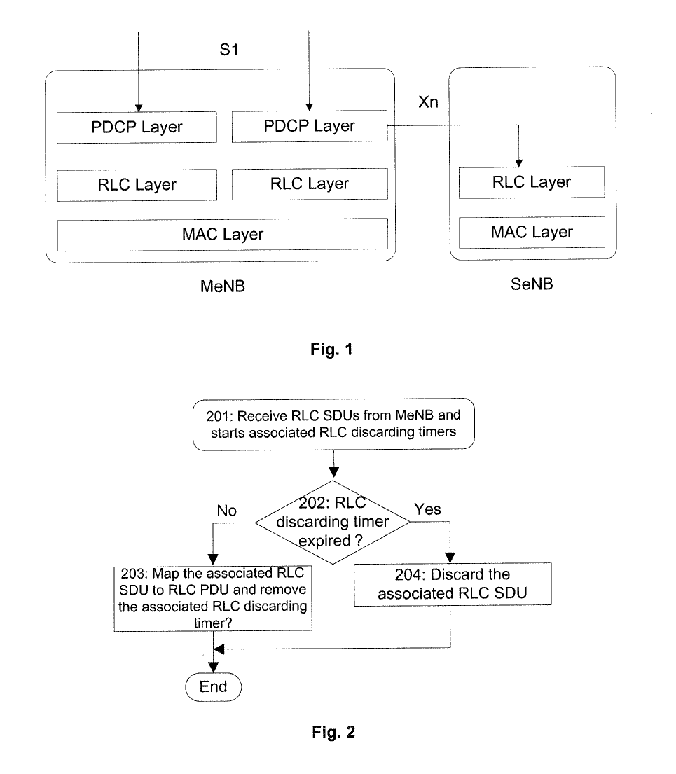

### DETAILED DESCRIPTION

The principles and implementations of the present disclosure will become more apparent from the following description of the embodiments taken in conjunction with the drawings. It should be noted that the following embodiments are illustrative only, rather than limiting the scope of the present disclosure. In the following description, details of well known techniques which are not directly relevant to the present invention will be omitted so as not to obscure the concept of the invention.

In the following, a number of embodiments of the present invention will be detailed in an exemplary application environment of LTE Release 12 mobile communication system and its subsequent evolutions. Herein, it is to be noted that the present invention is not limited to the application exemplified in the embodiments. Rather, it is applicable to other communication systems, such as the future 5G cellular communication system. Moreover, while the exemplary implementations of the solutions of the present disclosure are described here with reference to a situation where a MeNB and one SeNB cooperate to provide a UE with communication services, it can be appreciated that the solutions of the present disclosure also applies to a situation where a MeNB and more than one SeNB cooperate to provide a UE with communication services.

FIG. 2 is a flowchart illustrating a method for discarding an expired RLC SDU in a SeNB according to an embodiment of the present disclosure. The method shown in FIG. 2 includes the following steps.

At step 201, the SeNB receives RLC SDUs from a MeNB and starts a RLC discarding timer associated with each RLC SDU. In particular, the SeNB receives RLC SDUs from a MeNB and starts a RLC discarding timer associated with each RLC SDU. The timing period of the RLC discarding timer is carried in a request message requesting additional resources for a User Equipment (UE), or configured for the RLC entity in the SeNB by an inter-node Radio Resource Control (RRC) message via an Xn interface. The RRC message includes the following RLC-config information element segments:

| | |
|---|---|
| -- ASNISTART | |
| RLC-Config : := | CHOICE { |
| am | SEQUENCE { |
| ul-AM-RLC | UL-AM-RLC, |
| dl-AM-RLC | DL-AM-RLC |
| }, | |
| um-Bi-Directional | SEQUENCE { |
| ul-UM-RLC | UL-UM-RLC, |
| dl-UM-RLC | DL-UM-RLC |
| }, | |
| um-Uni-Directional-UL | SEQUENCE { |
| ul-UM-RLC | UL-UM-RLC |
| }, | |
| um-Uni-Directional-DL | SEQUENCE { |
| dl-UM-RLC | DL-UM-RLC |
| }, | |
| . . . | |
| } | |
| UL-AM-RLC : := | SEQUENCE { |
| t-PollRetransmit | T-PollRetransmit, |
| pollPDU | PollPDU, |
| pollByte | PollByte, |
| maxRetxThreshold | ENUMERATED { |
| | t1, t2, t3, t4, t6, t8, t16, t32} |
| } | |
| DL-AM-RLC : := | SEQUENCE { |
| t-Reordering | T-Reordering, |
| t-StatusProhibit | T-Status Prohibit |
| RLC-discardTimer | ENUMERATED { |
| | ms50, ms100, ms150, ms300, ms500, |
| | ms750, ms1500, infinity |
| } | OPTIONAL, -- Cond Setup |
| } | |
| UL-UM-RLC : := | SEQUENCE { |
| sn-FieldLength | SN-FieldLength |
| } | |
| DL-UM-RLC : := | SEQUENCE { |
| sn-FieldLength | SN-FieldLength, |
| t-Reordering | T-Reordering |
| RLC-discardTimer | ENUMERATED { |
| | ms50, ms100, ms150, ms300, ms500, |
| | ms750, ms1500, infinity |
| } | OPTIONAL, -- Cond Setup |
| } | |
| SN-FieldLength : := | ENUMERATED {size5, size10} |
| T-PollRetransmit : := | ENUMERATED { |
| | ms5, ms10, ms15, ms20, ms25, |
| | ms30, ms35, ms40, ms45, ms50, |
| | ms55, ms60, ms65, ms70, ms75, |
| | ms80, ms85, ms90, ms95, ms100, |
| | ms105, ms110, ms115, ms120, |
| | ms125, ms130, ms135, ms140, |
| | ms145, ms150, ms155, ms160, |
| | ms165, ms170, ms175, ms180, |
| | ms185, ms190, ms195, ms200, |
| | ms205, ms210, ms215, ms220, |
| | ms225, ms230, ms235, ms240, |
| | ms245, ms250, ms300, ms350, |
| | ms400, ms450, ms500, spare9, |
| | spare8, spare7, spare6, spare5, |
| | spare4, spare3, spare2, spare1} |
| PollPDU : := | ENUMERATED { |
| | p4, p8, p16, p32, p64, p128, p256, |
| | pInfinity} |
| PollByte : := | ENUMERATED { |
| | kB25, kB50, kB75, kB100, kB125, |
| | kB250, kB375, kB500, kB750, |
| | kB1000, kB1250, kB1500, kB2000, |
| | kB3000, kBinfinity, spare1} |
| T-Reordering : := | ENUMERATED { |
| | ms0, ms5, ms10, ms15, ms20, ms25, |
| | ms30, ms35, ms40, ms45, ms50, |
| | ms55, ms60, ms65, ms70, ms75, |
| | ms80, ms85, ms90, ms95, ms100, |
| | ms110, ms120, ms130, ms140, |
| | ms150, ms160, ms170, ms180, |
| | ms190, ms200, spare1} |
| T-StatusProhibit : := | ENUMERATED { |
| | ms0, ms5, ms10, ms15, ms20, m525, |
| | ms30, ms35, ms40, ms45, ms50, |
| | ms55, ms60, ms65, ms70, ms75, |
| | ms80, ms85, ms90, ms95, ms100, |
| | ms105, ms110, ms115, ms120, |
| | ms125, ms130, ms135, ms140, |
| | ms145, ms150, ms155, ms160, |
| | ms165, ms170, ms175, ms180, |
| | ms185, ms190, ms195, ms200, |
| | ms205, ms210, ms215, ms220, |
| | ms225, ms230, ms235, ms240, |
| | ms245, ms250, ms300, ms350, |
| | ms400, ms450, ms500, spare8, |
| | spare7, spare6, spare5, spare4, |
| | spare3, spare2, spare1} |
| -- ASN1STOP | |

In the above RLC-config information element segments, the field of RLC-discardtimer indicates discarding time for RLC SDU in units of milliseconds. For example, a value of ms50 represents 50 ms, a value of ms100 represents 100 ms, and so on. The value of RLC-discardtimer is not limited to those values shown in the RLC-config information element segments. In fact, the value of RLC-discardtimer should ensure that the RLC SDU is discarded at the time when, or after, its corresponding PDCP SDU is discarded. The value of RLC-discardtimer should be larger than or equal to PDCP discardtimer minus T_{MeNB-SeNB}, where T_{MeNB-SeNB} denotes time required for a PDCP PDU to be transmitted from the MeNB to the SeNB. For details of the other fields, reference can be made to 3GPP TS 36.331 Release 11 and the description thereof will be omitted here.

At step 202, the SeNB determines whether the RLC discarding timer associated with each RLC SDU received by the RLC entity has expired. If the RLC discarding timer has not expired, the method proceeds with step 203; otherwise it proceeds with step 204.

At step 203, the SeNB extracts unexpired RLC SDUs in sequence from an RLC SDU buffer, maps them to RLC PDUs, and removes the RLC discarding timers associated with those RLC SDUs. Here, the extracting of the unexpired RLC SDUs in sequence may include, but not limited to, extracting the unexpired RLC SDUs in an ascending order of the sequence numbers of the RLC SDUs, or in a chronological order of the received time of the RLC SDUs. In practice, an RLC SDU may be divided into several segments each mapped to different RLC PDUs. In this case, the timer can be removed when any segment of the RLC SDU has been mapped to an RLC PDU, rather than waiting until all the segments of the RLC SDU have been mapped to RLC PDUs.

At step 204, each RLC SDU having its associated RLC timer expired and having not been mapped to an RLC PDU is discarded.

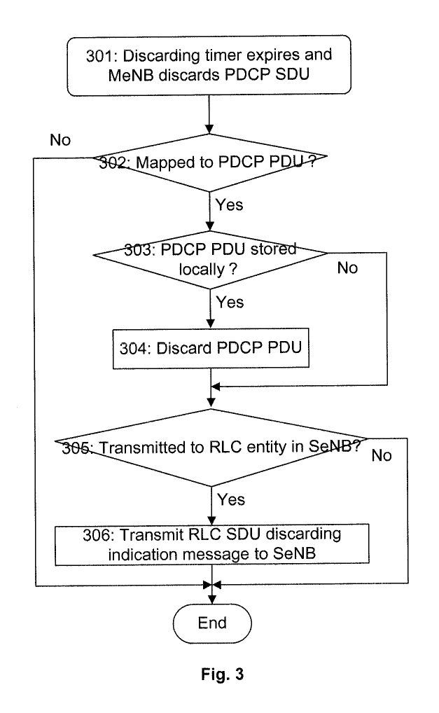

FIG. 3 is a flowchart illustrating a method for discarding an expired RLC SDU in a SeNB according to another embodiment of the present disclosure. The method shown in FIG. 3 includes the following steps.

At step 301, a discarding timer associated with a PDCP SDU expires and the PDCP SDU is discarded by a MeNB. In particular, the MeNB monitors a discarding timer associated with each PDCP SDU in a PDCP reception buffer and discards each PDCP SDU having its associated discarding timer expired from the reception buffer.

At step 302, the MeNB determines whether each PDCP SDU having its associated discarding timer expired has been mapped to a PDCP PDU. If so, the method proceeds with step 303; otherwise the MeNB continues monitoring the discarding timer for each received PDCP SDU.

At step 303, the MeNB determines whether a PDCP PDU to which the expired PDCP SDU is mapped is stored locally. If so, the method proceeds with step 304; otherwise the method proceeds with step 305.

At step 304, the MeNB discards the locally stored PDCP PDU.

At step 305, the MeNB determines whether a PDCP PDU to which the expired PDCP SDU is mapped has been transmitted to the RLC entity in the SeNB. If so, the method proceeds with step 306; otherwise the MeNB continues monitoring the discarding timer for each received PDCP SDU.

At step 306, the MeNB transmits to the SeNB an RLC SDU discarding indication message, such that the SeNB can discard the corresponding RLC SDUs, which have not been mapped to an RLC PDU, based on the indication message.

In an embodiment of the present disclosure, the indication message may contain one or more RLC SDU sequence numbers or a bitmap.

In the following, several examples will be given, where the indication message contains a number of RLC SDU sequence numbers, as described above.

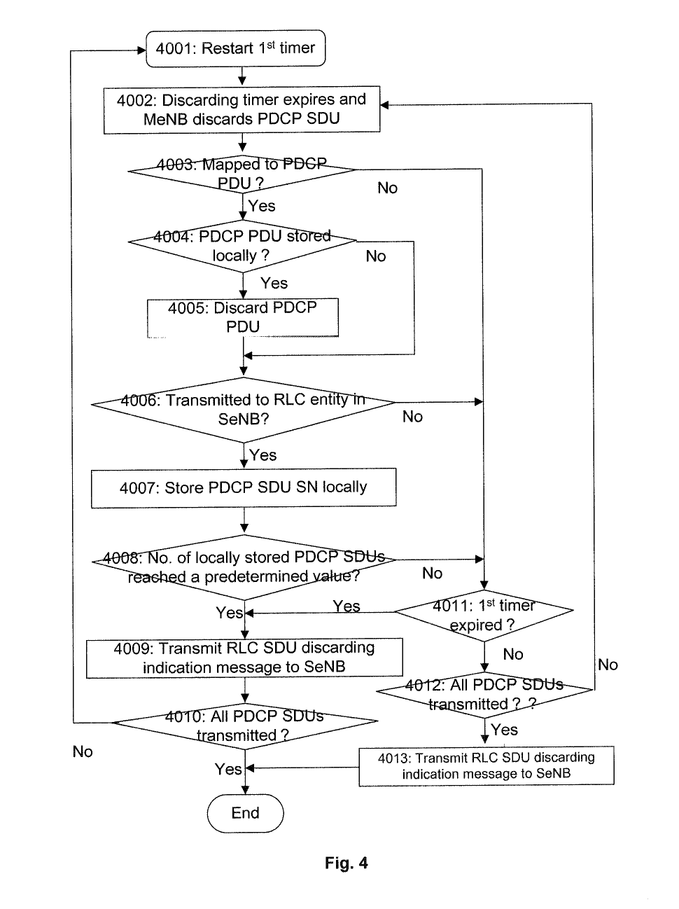

FIG. 4 is a flowchart illustrating a process in which the MeNB determines whether to transmit an RLC SDU discarding indication message to the SeNB by determining the number of expired PDCP SDUs according to an embodiment of the present disclosure. The method shown in FIG. 4 includes the following steps.

At step 4001, the MeNB sets, for the PDCP entity, a value of a first timer as an analysis period and starts the first timer. Here, the analysis period is a maximum time interval for the MeNB to transmit the RLC SDU discarding indication message to the SeNB and can be configured to the PDCP entity in the MeNB by means of RRC (re)-configuration.

At step 4002, a discarding timer associated with a PDCP SDU expires and the PDCP SDU is discarded by a MeNB. In particular, the MeNB monitors a discarding timer associated with each PDCP SDU in a PDCP reception buffer and discards each PDCP SDU having its associated discarding timer expired from the reception buffer.

At step 4003, the MeNB determines whether each PDCP SDU having its associated discarding timer expired has been mapped to a PDCP PDU. If so, the method proceeds with step 4004; otherwise the method proceeds with step 4011.

At step 4004, the MeNB determines whether a PDCP PDU to which the expired PDCP SDU is mapped is stored locally. If so, the method proceeds with step 4005; otherwise the method proceeds with step 4006.

At step 4005, the MeNB discards the locally stored PDCP PDU.

At step 4006, the MeNB determines whether a PDCP PDU to which the expired PDCP SDU is mapped has been transmitted to the RLC entity in the SeNB. If so, the method proceeds with step 4007; otherwise the method proceeds with step 4011.

At step 4007, the MeNB stores a sequence number of each expired PDCP SDU locally.

At step 4008, the MeNB determines whether the number of sequence numbers of expired PDCP SDUs as stored locally has reached a predetermined value. The predetermined value is the number of sequence numbers of expired PDCP SDUs that should be stored locally when the MeNB transmits an RLC SDU discarding indication message to the SeNB. The number of sequence numbers can be configured to the PDCP entity in the MeNB by means of RRC (re)-configuration. If the predetermined value has been reached, the method proceeds with step 4009; otherwise the method proceeds with step 4011.

At step 4009, the MeNB transmits to the SeNB an RLC SDU discarding indication message, such that the SeNB can discard the corresponding RLC SDUs, which have not been mapped to an RLC PDU, based on the indication message. The indication message contains a list of sequence numbers of the expired PDCP SDUs as stored locally. Optionally, the indication message can further contain the number of sequence numbers of the expired PDCP SDUs as stored locally.

At step 4010, the MeNB determines whether all the PDCP SDUs have been transmitted. If so, the method ends; otherwise the method proceeds with step 4001.

At step 4011, the MeNB determines whether the first timer has expired. The first timer defines a maximum time interval for the MeNB to transmit an RLC SDU discarding indication message to the SeNB and its value can be configured to the PDCP entity in the MeNB by means of RRC (re)-configuration. If the first timer has expired, the method proceeds with step 4009; otherwise the method proceeds with step 4012.

At step 4012, the MeNB determines whether all the PDCP SDUs have been transmitted. If so, the method proceeds with step 4013; otherwise the method proceeds with step 4002.

At step 4013, the MeNB transmits an RLC SDU discarding indication message to the SeNB.

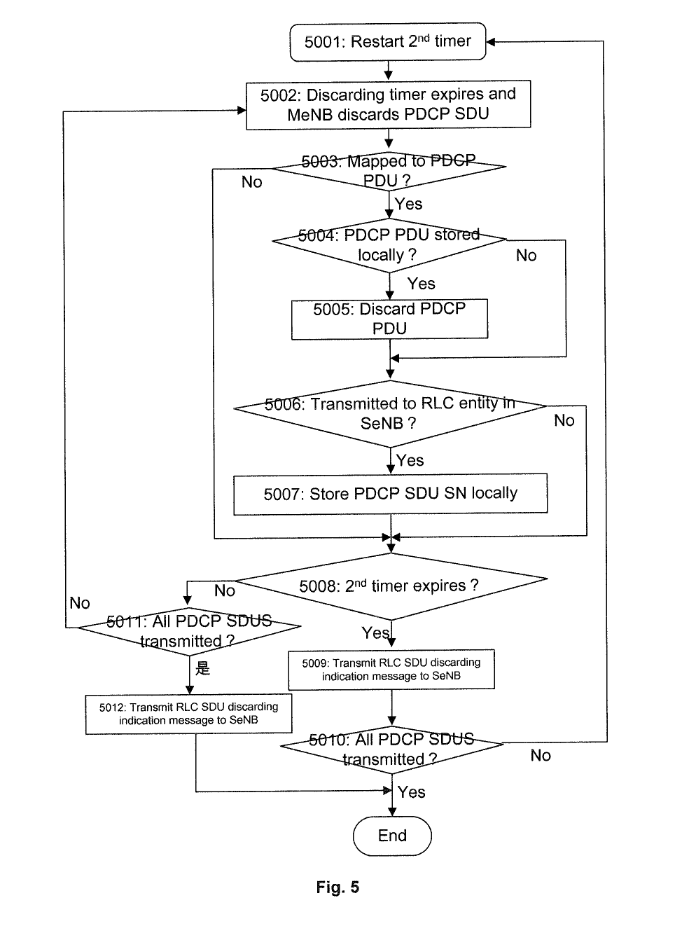

FIG. 5 is a flowchart illustrating a process in which the MeNB determines whether to transmit an RLC SDU discarding indication message to the SeNB by determining whether a second timer has expired according to an embodiment of the present disclosure. The method shown in FIG. 5 includes the following steps.

At step 5001, the MeNB sets, for the PDCP entity, a value of a second timer as an analysis period and starts the second timer. Here, the analysis period is a time interval for the MeNB to transmit the RLC SDU discarding indication message to the SeNB and can be configured to the PDCP entity in the MeNB by means of RRC (re)-configuration.

At step 5002, a discarding timer associated with a PDCP SDU expires and the PDCP SDU is discarded by a MeNB. In particular, the MeNB monitors a discarding timer associated with each PDCP SDU in a PDCP reception buffer and discards each PDCP SDU having its associated discarding timer expired from the reception buffer.

At step 5003, the MeNB determines whether each PDCP SDU having its associated discarding timer expired has been mapped to a PDCP PDU. If so, the method proceeds with step 5004; otherwise the method proceeds with step 5008.

At step 5004, the MeNB determines whether a PDCP PDU to which the expired PDCP SDU is mapped is stored locally. If so, the method proceeds with step 5005; otherwise the method proceeds with step 5006.

At step 5005, the MeNB discards the locally stored PDCP PDU.

At step 5006, the MeNB determines whether a PDCP PDU to which the expired PDCP SDU is mapped has been transmitted to the RLC entity in the SeNB. If so, the method proceeds with step 5007; otherwise the method proceeds with step 5008.

At step 5007, the MeNB stores a sequence number of each expired PDCP SDU locally.

At step 5008, the MeNB determines whether the second timer has expired. If the second timer has expired, the method proceeds with step 5009; otherwise the method proceeds with step 5011.

At step 5009, the MeNB transmits to the SeNB an RLC SDU discarding indication message, such that the SeNB can discard the corresponding RLC SDUs, which have not been mapped to an RLC PDU, based on the indication message. The indication message contains a list of sequence numbers of the expired PDCP SDUs as stored locally. Optionally, the indication message can further contain the number of sequence numbers of the expired PDCP SDUs as stored locally.

At step 5010, the MeNB determines whether all the PDCP SDUs have been transmitted. If so, the method ends; otherwise the method proceeds with step 5001.

At step 5011, the MeNB determines whether all the PDCP SDUs have been transmitted. If so, the method proceeds with step 5012; otherwise the method proceeds with step 5002.

At step 5012, the MeNB transmits an RLC SDU discarding indication message to the SeNB.

In the following, some examples of the bitmap included in the indication message will be explained with reference to the figure.

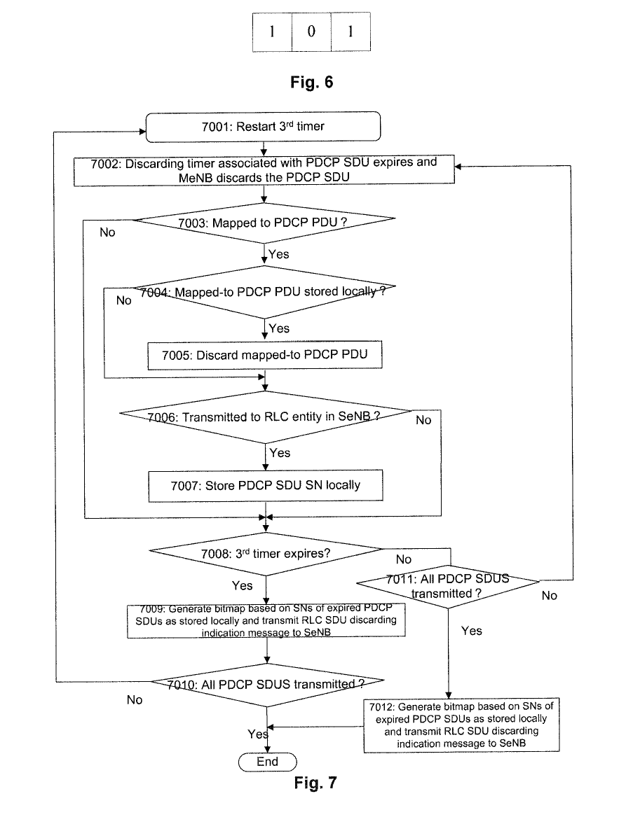

FIG. 6 is a schematic diagram showing a structure of a bitmap. The bitmap shown in FIG. 6 may have a fixed or variable length. Each indication bit in the bitmap having a value of 1 indicates that its corresponding PDCP SDU has expired and a value of 0 indicates that its corresponding PDCP SDU has not expired. For each PDCP SDU transmitted by the MeNB, its associated indication bit in the bitmap has a value of 0 regardless of whether it has expired not. For example, there are 10 PDCP SDUs to be transmitted in the MeNB, among which the PDCP SDUs having sequence numbers of 1, 2, 5, 7 and 9 are transmitted by the RLC entity at the MeNB and the PDCP SDUs having sequence numbers of 0, 3, 4, 6 and 8 are transmitted by the RLC entity at the SeNB. Assuming that the minimum sequence number among the expired PDCP SDUs is 3, the sequence numbers of the expired PDCP SDU corresponding to the bitmap shown in FIG. 6 are 4 and 6, respectively. Since the PDCP SDU having a sequence number of 5 is transmitted by the RLC entity in the MeNB, it corresponding indication bit in the bitmap has a value of 0 regardless whether it has expired or not. The sequence number of the PDCP SDU having a sequence number of 3 is indicated in the field of the minimum sequence number among the expired PDCP SDUs in the message header of the indication message and is thus omitted in the bitmap.

FIG. 7 is a flowchart illustrating a method with a bitmap with a variable length according to an embodiment of the present disclosure. The method shown in FIG. 7 includes the following steps.

At step 7001, the MeNB sets, for the PDCP entity, a value of a third timer as an analysis period and starts the third timer. Here, the analysis period is a time interval for the MeNB to transmit the RLC SDU discarding indication message to the SeNB and can be configured to the PDCP entity in the MeNB by means of RRC (re)-configuration.

At step 7002, the PDCP entity in the MeNB monitors a discarding timer associated with each PDCP SDU received from a higher layer and discards each PDCP SDU having its associated discarding timer expired.

At step 7003, the MeNB determines whether each discarded PDCP SDU has been mapped to a PDCP PDU. If so, the method proceeds with step 7004; otherwise the method proceeds with step 7008.

At step 7004, the MeNB determines whether a PDCP PDU to which the discarded PDCP SDU is mapped is stored locally. If so, the method proceeds with step 7005; otherwise the method proceeds with step 7006.

At step 7005, the MeNB discards the PDCP PDU to which the discarded PDCP SDU is mapped.

At step 7006, the MeNB determines whether the PDCP PDU to which the discarded PDCP SDU is mapped has been transmitted to the RLC entity in the SeNB. If so, the method proceeds with step 7007; otherwise the method proceeds with step 7008.

At step 7007, the MeNB stores a sequence number of the PDCP SDU

At step 7008, the MeNB determines whether the third timer has expired. If the third timer has expired, the method proceeds with step 7009; otherwise the method proceeds with step 7011.

At step 7009, the MeNB transmits to the SeNB an RLC SDU discarding indication message, such that the SeNB can discard the corresponding RLC SDUs, which have not been mapped to an RLC PDU, based on the indication message. The indication message contains a minimum sequence number among the expired PDCP SDUs as stored locally at the MeNB and a bitmap generated by the MeNB based on the sequence numbers of the expired PDCP SDUs as stored locally. Optionally, the indication message may further include a length of the bitmap.

At step 7010, the MeNB determines whether all the PDCP SDUs have been transmitted. If so, the method ends; otherwise the method proceeds with step 7001.

At step 7011, the MeNB determines whether all the PDCP SDUs have been transmitted. If so, the method proceeds with step 7012; otherwise the method proceeds with step 7002.

At step 7012, the MeNB transmits to the SeNB an RLC SDU discarding indication message, such that the SeNB can discard the corresponding RLC SDUs, which have not been mapped to an RLC PDU, based on the indication message. The indication message contains a minimum sequence number among the expired PDCP SDUs as stored locally at the MeNB and a bitmap generated by the MeNB based on the sequence numbers of the expired PDCP SDUs as stored locally. Optionally, the indication message may further include a length of the bitmap.

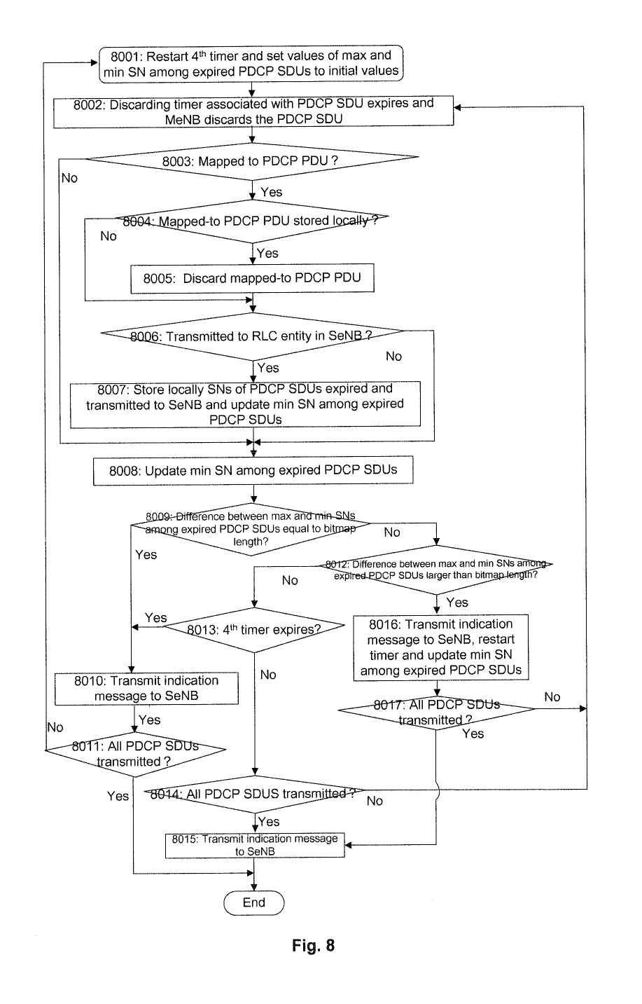

FIG. 8 is a flowchart illustrating a method with a bitmap with a fixed length according to an embodiment of the present disclosure. The method shown in FIG. 8 includes the following steps.

At step 8001, the MeNB sets, for the PDCP entity, a value of a fourth timer as an analysis period and starts the fourth timer. Here, the analysis period is a time interval for the MeNB to transmit the RLC SDU discarding indication message to the SeNB and can be configured to the PDCP entity in the MeNB by means of RRC (re)-configuration. Here, a maximum sequence number among the expired PDCP SDUs and a minimum sequence number among the expired PDCP SDUs are set to their respective initial values which are special values different from any sequence number of any PDCP SDU to be transmitted, e.g., −1, indefinitely great, or indefinitely small.

At step 8002, the PDCP entity in the MeNB monitors a discarding timer associated with each PDCP SDU received from a higher layer and discards each PDCP SDU having its associated discarding timer expired.

At step 8003, the MeNB determines whether each discarded PDCP SDU has been mapped to a PDCP PDU. If so, the method proceeds with step 8004; otherwise the method proceeds with step 8008.

At step 8004, the MeNB determines whether a PDCP PDU to which the discarded PDCP SDU is mapped is stored locally. If so, the method proceeds with step 8005; otherwise the method proceeds with step 8006.

At step 8005, the MeNB discards the PDCP PDU to which the discarded PDCP SDU is mapped.

At step 8006, the MeNB determines whether the PDCP PDU to which the discarded PDCP SDU is mapped has been transmitted to the RLC entity in the SeNB. If so, the method proceeds with step 8007; otherwise the method proceeds with step 8008.

At step 8007, the MeNB stores locally a sequence number of each PDCP SDU that has expired and has been transmitted to the RLC entity in the SeNB. If the minimum sequence number among the expired PDCP SDUs is the initial value or is larger than the locally stored sequence number of the expired PDCP SDU, the minimum sequence number among the expired PDCP SDUs set to the locally stored sequence number of the expired PDCP SDU.

At step 8008, if the maximum sequence number among the expired PDCP SDUs is the initial value or is smaller than the sequence number of the discarded expired PDCP SDU, the maximum sequence number among the expired PDCP SDUs is updated with the sequence number of the discarded expired PDCP SDU.

At step 8009, the MeNB determines whether a difference between the maximum sequence number and the minimum among the expired PDCP SDUs equals to a length of a bitmap. If so, the method proceeds with step 8010; otherwise the method proceeds with step 8012. The length of the bitmap can be configured to the PDCP entity in the MeNB by means of RRC (re)-configuration.

At step 8010, the MeNB transmits to the SeNB an RLC SDU discarding indication message, such that the SeNB can discard the corresponding RLC SDUs, which have not been mapped to an RLC PDU, based on the indication message. The indication message contains the minimum sequence number among the expired PDCP SDUs as stored locally at the MeNB and the bitmap generated by the MeNB based on the sequence numbers of the expired PDCP SDUs as stored locally.

At step 8011, the MeNB determines whether all the PDCP SDUs have been transmitted. If so, the method ends; otherwise the method proceeds with step 8001.

At step 8012, the MeNB determines whether the difference between the maximum sequence number and the minimum among the expired PDCP SDUs equals to the length of the bitmap. If so, the method proceeds with step 8016; otherwise the method proceeds with step 8013.

At step 8013, the MeNB determines whether the fourth timer has expired. If the fourth timer has expired, the method proceeds with step 8010; otherwise the method proceeds with step 8013.

At step 8014, the MeNB determines whether all the PDCP SDUs have been transmitted. If so, the method proceeds with step 8015; otherwise the method proceeds with step 8002.

At step 8015, the MeNB transmits to the SeNB an RLC SDU discarding indication message, such that the SeNB can discard the corresponding RLC SDUs, which have not been mapped to an RLC PDU, based on the indication message. The indication message contains the minimum sequence number among the expired PDCP SDUs as stored locally at the MeNB and the bitmap generated by the MeNB based on the sequence numbers of the expired PDCP SDUs as stored locally.

At step 8016, the MeNB transmits to the SeNB an RLC SDU discarding indication message, such that the SeNB can discard the corresponding RLC SDUs, which have not been mapped to an RLC PDU, based on the indication message. The indication message contains the minimum sequence number among the expired PDCP SDUs as stored locally at the MeNB and the bitmap generated by the MeNB based on the sequence numbers of the expired PDCP SDUs as stored locally. The MeNB restarts the fourth timer. If the PDCP SDU to which the most recently expired PDCP SDU is mapped is transmitted by the RLC SDU of the SeNB, the minimum sequence number among the expired PDCP SDUs is set to the sequence number of the most recently expired PDCP SDU; otherwise the minimum sequence number among the expired PDCP SDUs is set to the initial value.

At step 8017, the MeNB determines whether all the PDCP SDUs have been transmitted. If so, the method proceeds with step 8015; otherwise the method proceeds with step 8002.

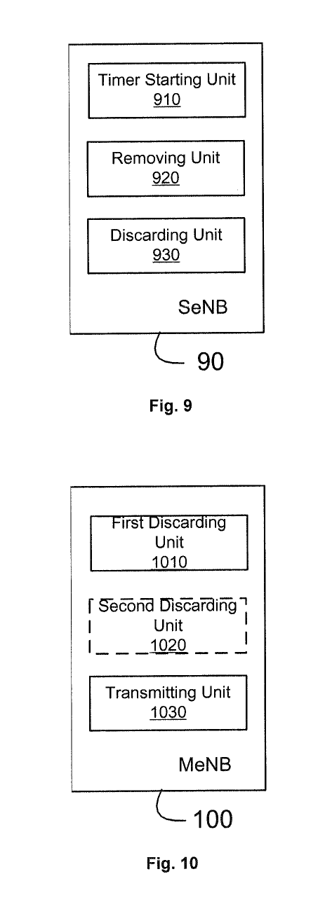

FIG. 9 is a block diagram of a SeNB according to an embodiment of the present disclosure. As shown in FIG. 9, the SeNB 90 in this embodiment includes a timer starting unit 910, a removing unit 920 and a discarding unit 930.

The timer starting unit 910 is configured to start a RLC discarding timer associated with the RLC SDU received from the MeNB.

The removing unit 920 is configured to remove the RLC discarding timer when the RLC discarding timer has not expired and any portion of the RLC SDU has been mapped to a RLC Protocol Data Unit (PDU).

The discarding unit 930 is configured to discard the RLC SDU when the RLC discarding timer expires.

Preferably, the RLC discarding timer is set in response to a request message requesting additional resources for a User Equipment (UE) or in response to an inter-node Radio Resource Control (RRC) message. More preferably, the RLC discarding timer satisfies a condition that its associated RLC SDU is discarded at the time when, or after, a corresponding Packet Data Convergence Protocol (PDCP) SDU in the MeNB expires.

FIG. 10 is a block diagram of a MeNB according to an embodiment of the present disclosure. As shown in FIG. 10, the MeNB 100 in this embodiment includes a first discarding unit 1010 and a transmitting unit 1030.

The first discarding unit 1010 is configured to discard, when a discarding timer associated with a Packet Data Convergence Protocol (PDCP) SDU expires.

Optionally, the MeNB can further include a second discarding unit 1020 configured to discard, when the PDCP PDU to which the discarded PDCP SDU is mapped is stored locally, the PDCP PDU.

The transmitting unit 1030 is configured to transmit, when a PDCP Protocol Data Unit (PDU) corresponding to the discarded PDCP SDU has been transmitted to the SeNB, an indication message to the SeNB to discard the RLC SDU corresponding to the PDCP PDU.

In a preferred embodiment, the MeNB can further include a storage unit (not shown) configured to store a sequence number of each PDCP SDU that has expired. In this case, the transmitting unit 1030 is configured to transmit the indication message to the SeNB when there are a preset number of sequence numbers of expired PDCP SDUs that have been stored, or when a first timer expires, the first timer defining a maximum time interval for the MeNB to transmit the indication message to the SeNB.

In a preferred embodiment, the MeNB can further include a storage unit (not shown) configured to store a sequence number of each PDCP SDU that has expired. In this case, the transmitting unit 1030 is configured to transmit the indication message to the SeNB when a second timer expires, the second timer defining a time interval for the MeNB to transmit the indication message to the SeNB.

In a preferred embodiment, the MeNB can further include a storage unit (not shown) configured to store a sequence number of each PDCP SDU that has expired. In this case, the transmitting unit 1030 is configured to transmit the indication message to the SeNB when a third timer expires, the third timer defining a time interval for the MeNB to transmit the indication message to the SeNB. The indication message includes a minimum sequence number among the expired PDCP SDUs, a bitmap length, and a bitmap of the expired PDCP SDUs, the minimum sequence number being a minimum sequence number among PDCP SDUs that have been transmitted by the SeNB and have expired during a timing period of the third timer.

In a preferred embodiment, the MeNB can further include a storage unit (not shown) configured to store a sequence number of each PDCP SDU that has expired. In this case, the transmitting unit 1030 is configured to transmit the indication message to the SeNB when a difference between a maximum sequence number and a minimum sequence number among the expired PDCP SDUs is larger than or equal to a length of a bitmap, or when a fourth timer expires, the fourth timer defining a maximum time interval for the MeNB to transmit the indication message to the SeNB. The indication message includes the minimum sequence number among the expired PDCP SDUs and the bitmap, the maximum sequence number being a maximum sequence number among PDCP SDUs that have expired in the MeNB during a timing period of the fourth timer, the minimum sequence number being a minimum sequence number among PDCP SDUs that have been transmitted by the SeNB and have expired during the timing period of the fourth timer.

Preferably, the first, second, third or fourth timer is configured via a Radio Resource Control (RRC) configuration/reconfiguration message.

In an embodiment of the present disclosure, the bitmap length can be transmitted in a request message transmitted from the MeNB to the SeNB for requesting additional resources to be allocated to the UE, or configured for the RLC entity in the SeNB in an inter-eNB RRC message via an Xn interface.

According to the present disclosure, an RLC SDU received from a MeNB can be discarded in the SeNB when no portion of the RLC SDU has been mapped to an RLC PDU and its corresponding PDCP SDU has been discarded due to expiration. In this way, with the present disclosure, it is possible to save storage space by reducing storage of expired RLC SDUs in the SeNB and save radio transmission resources by avoiding transmission of expired RLC SDUs.

It can be appreciated that the above embodiments of the present disclosure can be implemented in software, hardware or any combination thereof. For example, the internal components of the base station and the UE in the above embodiments can be implemented using various devices including, but not limited to, analog circuit device, digital circuit device, Digital Signal Processing (DSP) circuit, programmable processor, Application Specific Integrated Circuit (ASIC), Field Programmable Gate Array (FPGA), Programmable Logic Device (CPLD) and the like.

In the present disclosure, the term “base station” means a mobile communication data and control exchange center with a large transmit power and a wide coverage area and including functions such as resource allocation/scheduling, data reception/transmission and the like. The term “user equipment” means a user mobile terminal, including e.g., a mobile phone, a notebook computer and other terminal devices that can wirelessly communicate with a base station or and micro base station.

Further, the embodiments of the present disclosure can be implemented in computer program products. More specifically, a computer program product can be a product having a computer readable medium with computer program logics coded thereon. When executed on a computing device, the computer program logics provide operations for implementing the above solutions according to the present disclosure. When executed on at least one processor in a computing system, the computer program logics cause the processor to perform the operations (methods) according to the embodiments of the present disclosure. This arrangement of the present disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules. The software, firmware or arrangement can be installed in a computing device to cause one or more processors in the computing device to perform the solutions according to the embodiments of the present disclosure.

The present disclosure has been described above with reference to the preferred embodiments thereof. It should be understood that various modifications, alternations and additions can be made by those skilled in the art without departing from the spirits and scope of the present disclosure. Therefore, the scope of the present disclosure is not limited to the above particular embodiments but only defined by the claims as attached and the equivalents thereof.

1. A method performed in a Secondary evolved NodeB (SeNB) for discarding a Radio Link Control (RLC) Service Data Unit (SDU) received from a Master eNB (MeNB), comprising:
starting a RLC discarding timer associated with the RLC SDU received from the MeNB;
removing the RLC discarding timer when the RLC discarding timer has not expired and any portion of the RLC SDU has been mapped to a RLC Protocol Data Unit (PDU); and
discarding the RLC SDU when the RLC discarding timer expires.

2. The method of claim 1, wherein
the RLC discarding timer is set in response to a request message requesting additional resources for a User Equipment (UE) or in response to an inter-node Radio Resource Control (RRC) message, and
the RLC discarding timer satisfies a condition that its associated RLC SDU is discarded at the time when, or after, a corresponding Packet Data Convergence Protocol (PDCP) SDU in the MeNB expires.

3. A method performed in a Master evolved NodeB (MeNB) for discarding a Radio Link Control (RLC) Service Data Unit (SDU) received from the Master eNB (MeNB) in a Secondary eNB (SeNB), comprising:
discarding, when a discarding timer associated with a Packet Data Convergence Protocol (PDCP) SDU expires, the PDCP SDU; and
transmitting, when a PDCP Protocol Data Unit (PDU) corresponding to the discarded PDCP SDU has been transmitted to the SeNB, an indication message to the SeNB to discard the RLC SDU corresponding to the PDCP PDU.

4. The method of claim 3, wherein, when the PDCP PDU to which the discarded PDCP SDU is mapped is stored locally, the PDCP PDU is discarded.

5. The method of claim 3, further comprising:
storing a sequence number of each PDCP SDU that has expired;
transmitting the indication message to the SeNB when there are a preset number of sequence numbers of expired PDCP SDUs that have been stored, or when a first timer expires, the first timer defining a maximum time interval for the MeNB to transmit the indication message to the SeNB.

6. The method of claim 3, further comprising:
storing a sequence number of each PDCP SDU that has expired;
transmitting the indication message to the SeNB when a second timer expires, the second timer defining a time interval for the MeNB to transmit the indication message to the SeNB.

7. The method of claim 3, further comprising:
storing a sequence number of each PDCP SDU that has expired;
transmitting the indication message to the SeNB when a third timer expires, the third timer defining a time interval for the MeNB to transmit the indication message to the SeNB,
wherein the indication message includes a minimum sequence number among the expired PDCP SDUs and a bitmap of the expired PDCP SDUs, the minimum sequence number being a minimum sequence number among PDCP SDUs that have been transmitted by the SeNB and have expired during a timing period of the third timer.

8. The method of claim 3, further comprising:
storing a sequence number of each PDCP SDU that has expired;
transmitting the indication message to the SeNB when a difference between a maximum sequence number and a minimum sequence number among the expired PDCP SDUs is larger than or equal to a length of a bitmap, or when a fourth timer expires, the fourth timer defining a maximum time interval for the MeNB to transmit the indication message to the SeNB,
wherein the indication message includes the minimum sequence number among the expired PDCP SDUs and the bitmap, the maximum sequence number being a maximum sequence number among PDCP SDUs that have expired in the MeNB during a timing period of the fourth timer, the minimum sequence number being a minimum sequence number among PDCP SDUs that have been transmitted by the SeNB and have expired during the timing period of the fourth timer.

9. The method of claim 5, wherein the first, second, third or fourth timer is configured via a Radio Resource Control (RRC) configuration/reconfiguration message.

10. A Secondary evolved NodeB (SeNB) for discarding a Radio Link Control (RLC) Service Data Unit (SDU) received from a Master eNB (MeNB), comprising:
a timer starting unit configured to start a RLC discarding timer associated with the RLC SDU received from the MeNB;
a removing unit configured to remove the RLC discarding timer when the RLC discarding timer has not expired and any portion of the RLC SDU has been mapped to a RLC Protocol Data Unit (PDU); and
a discarding unit configured to discard the RLC SDU when the RLC discarding timer expires.

11. The SeNB of claim 10, wherein
the RLC discarding timer is set in response to a request message requesting additional resources for a User Equipment (UE) or in response to an inter-node Radio Resource Control (RRC) message, and
the RLC discarding timer satisfies a condition that its associated RLC SDU is discarded at the time when, or after, a corresponding Packet Data Convergence Protocol (PDCP) SDU in the MeNB expires.

12. A Master evolved NodeB (MeNB) for discarding a Radio Link Control (RLC) Service Data Unit (SDU) received from the Master eNB (MeNB) in a Secondary eNB (SeNB), comprising:
a first discarding unit configured to discard, when a discarding timer associated with a Packet Data Convergence Protocol (PDCP) SDU expires, the PDCP SDU; and
a transmitting unit configured to transmit, when a PDCP Protocol Data Unit (PDU) corresponding to the discarded PDCP SDU has been transmitted to the SeNB, an indication message to the SeNB to discard the RLC SDU corresponding to the PDCP PDU.

13. The MeNB of claim 12, further comprising:
a second discarding unit configured to discard, when the PDCP PDU to which the discarded PDCP SDU is mapped is stored locally, the PDCP PDU.

14. The MeNB of claim 12, further comprising:
a storage unit configured to store a sequence number of each PDCP SDU that has expired;
wherein the transmitting unit is configured to transmit the indication message to the SeNB when there are a preset number of sequence numbers of expired PDCP SDUs that have been stored, or when a first timer expires, the first timer defining a maximum time interval for the MeNB to transmit the indication message to the SeNB.

15. The MeNB of claim 12, further comprising:
a storage unit configured to store a sequence number of each PDCP SDU that has expired;
wherein the transmitting unit is configured to transmit the indication message to the SeNB when a second timer expires, the second timer defining a time interval for the MeNB to transmit the indication message to the SeNB.

16. The MeNB of claim 12, further comprising:
a storage unit configured to store a sequence number of each PDCP SDU that has expired;
wherein the transmitting unit is configured to transmit the indication message to the SeNB when a third timer expires, the third timer defining a time interval for the MeNB to transmit the indication message to the SeNB, and
wherein the indication message includes a minimum sequence number among the expired PDCP SDUs and a bitmap of the expired PDCP SDUs, the minimum sequence number being a minimum sequence number among PDCP SDUs that have been transmitted by the SeNB and have expired during a timing period of the third timer.

17. The MeNB of claim 12, further comprising:
a storage unit configured to store a sequence number of each PDCP SDU that has expired;
wherein the transmitting unit is configured to transmit the indication message to the SeNB when a difference between a maximum sequence number and a minimum sequence number among the expired PDCP SDUs is larger than or equal to a length of a bitmap, or when a fourth timer expires, the fourth timer defining a maximum time interval for the MeNB to transmit the indication message to the SeNB, and
wherein the indication message includes the minimum sequence number among the expired PDCP SDUs and the bitmap, the maximum sequence number being a maximum sequence number among PDCP SDUs that have expired in the MeNB during a timing period of the fourth timer, the minimum sequence number being a minimum sequence number among PDCP SDUs that have been transmitted by the SeNB and have expired during the timing period of the fourth timer.

18. The MeNB of claim 14, wherein the first, second, third or fourth timer is configured via a Radio Resource Control (RRC) configuration/reconfiguration message.
